(19) United States
(12) Patent Application Publication
(10) Pub. No.: US 2013/0305344 A1
(43) Pub. Date: Nov. 14, 2013

(54) ENTERPRISE NETWORK SERVICES OVER DISTRIBUTED CLOUDS

(71) Applicants: Mansoor Alicherry, Bengalura (IN); Pramod V. Koppol, Manalapan, NJ (US)

(72) Inventors: Mansoor Alicherry, Bengalura (IN); Pramod V. Koppol, Manalapan, NJ (US)

(73) Assignees: Alcatel-Lucent India Limited, Bangalore (IN); Alcatel-Lucent USA Inc., Murray Hill, NJ (US)

(21) Appl. No.: 13/471,062

(22) Filed: May 14, 2012

(51) Int. Cl. G06F 21/00; G06F 15/16

(52) U.S. Cl. 726/12

(57) ABSTRACT

Various exemplary embodiments relate to a method and related network node including one or more of the following: determining that a new virtual gateway location should be created; selecting a data center of a plurality of data centers to host the new virtual gateway location; and establishing a virtual gateway at the selected data center, wherein the virtual gateway is configured to provide at least one device with connectivity to a Virtual Private Network (VPN) and connectivity to the Internet.

### TECHNICAL FIELD

Various exemplary embodiments disclosed herein relate generally to cloud computing.

### BACKGROUND

Since the advent of wide area networking, enterprises may provide multiple, geographically distributed sites that may be interconnected by way of an intranet. In some cases, the intranet may leverage virtual private networking (VPN) to provide such connectivity without exposing unencrypted traffic to the Internet. The enterprise may also provide policy-based Internet access to devices on the intranet through a central gateway. Under such a configuration, traffic destined for the Internet may be routed over the VPN to the central gateway which may then enforce various traffic policies and then pass the traffic to the open Internet for further routing. This solution may not scale well, however, as the number of enterprise sites and the average bandwidth used per device increases. A requirement that all Internet-destined traffic be first routed to a central gateway may place additional and, in some cases, unsustainable load on the VPN.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a cloud controller for providing a network service, the method including one or more of the following: determining that a new virtual gateway location should be created; selecting a data center of a plurality of data centers to host the new virtual gateway location; and establishing a virtual gateway at the selected data center, wherein the virtual gateway is configured to provide at least one device with connectivity to a Virtual Private Network (VPN) and connectivity to the Internet.

Various exemplary embodiments relate to a cloud controller for providing a network service, the cloud controller including: a memory; and a processor communicatively connected to the memory configured to: determine that a new virtual gateway location should be created, select a data center of a plurality of data centers to host the new virtual gateway location, and establish a virtual gateway at the selected data center, wherein the virtual gateway is configured to provide at least one device with connectivity to a Virtual Private Network (VPN) and connectivity to the Internet.

Various embodiments additionally include establishing a virtual remote access gateway at the selected data center, wherein the virtual remote access gateway is configured to provide a device outside the VPN with access to the VPN.

Various embodiments additionally include establishing a virtual firewall at the selected data center, wherein the virtual firewall is configured to filter traffic associated with the virtual gateway.

Various embodiments are described wherein the step of determining that a new virtual gateway location should be created includes receiving an instruction to create a new virtual gateway location.

Various embodiments are described wherein the step of determining that a new virtual gateway location should be created includes: receiving, from an enterprise server, a virtual site policy, wherein the virtual site policy includes criteria for determining when a new virtual gateway location should be created; and determining that the criteria have been met by the current state of the Virtual Private Network.

Various embodiments are described wherein the at least one device includes customer premise equipment.

Various embodiments are described wherein the step of selecting a data center of a plurality of data centers to host the new virtual gateway location is performed based on the geographic distance between the data center and the at least one device.

Various exemplary embodiments relate to a method performed by at least one cloud device for providing a network service, the method including one or more of the following: hosting a gateway virtual machine, wherein the gateway virtual machine performs the steps of: receiving, via an interface of the at least one cloud device, a first packet to be forwarded; extracting a destination address from the packet; determining whether the destination address corresponds to a remote enterprise site or a device on the Internet; transmitting the first packet to a Virtual Private Network (VPN) router based on a correspondence between the destination address and a remote enterprise site; and transmitting the first packet to a border gateway based on a correspondence between the destination address.

Various exemplary embodiments relate to a machine readable storage medium encoded with instructions for execution by at least one cloud device for providing a network service, the medium including one or more of the following: instructions for hosting a gateway virtual machine including: instructions for receiving, via an interface of the at least one cloud device, a first packet to be forwarded; instructions for extracting a destination address from the packet; instructions for determining whether the destination address corresponds to a remote enterprise site or a device on the Internet; instructions for transmitting the first packet to a Virtual Private Network (VPN) router based on a correspondence between the destination address and the remote enterprise site; and instructions for transmitting the first packet to a border gateway based on a correspondence between the destination address and the Internet.

Various embodiments are described wherein the gateway virtual machine receives the first packet from a customer premise equipment device.

Various embodiments are described wherein the at least one cloud device further hosts a remote access gateway virtual machine that performs the steps of: receiving a second packet from the Border Gateway; and forwarding the second packet to a device connected to the VPN.

Various embodiments are described wherein the at least one cloud device further hosts a firewall virtual machine that filters packets associated with the gateway virtual machine.

Various embodiments are described wherein the step of transmitting the first packet to a border gateway includes performing network address translation (NAT).

Various embodiments additionally include performing, by the gateway virtual device, the step of advertising, to the border gateway, a route to a device from which the first packet originated.

Various embodiments are described wherein at least one of the VPN router and the border gateway are virtual machines hosted by the at least one cloud device.

### BRIEF DESCRIPTION OF THE DRAWINGS

In order to better understand various exemplary embodiments, reference is made to the accompanying drawings, wherein:

FIG. 1 illustrates an exemplary service provider cloud for providing network services;

FIG. 2 illustrates an exemplary distributed enterprise network architecture;

FIG. 3 illustrates an exemplary routing architecture for a virtual gateway location;

FIG. 4 illustrates an exemplary method for forwarding packets at a virtual gateway site; and

FIG. 5 illustrates an exemplary method for establishing a virtual gateway site.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

According to the foregoing, there exists a need for a method and apparatus capable of providing policy-controlled external network access to distributed enterprise networks that reduces the load on internal resources. In particular, it would be desirable to provide such a method and apparatus that provides Internet access while reducing the load placed on an internal virtual private network (VPN).

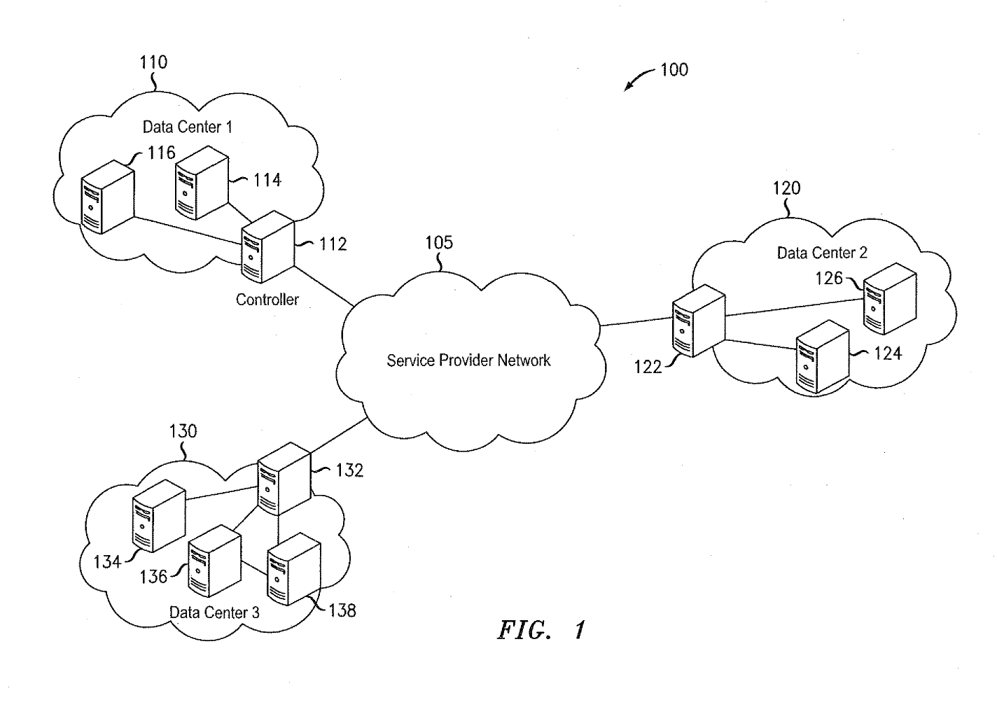

FIG. 1 illustrates an exemplary service provider cloud 100 for providing network services. Exemplary service provider cloud 100 may include a service provider network providing connectivity between multiple data centers 110, 120, 130. Service provider cloud 100 may be run and operated by a service provider to provide cloud-based services to various enterprises. It will be apparent that service provider cloud 100 is an example of one cloud arrangement and various alternative arrangements may be used. For example, fewer or additional data centers may be present.

Service provider network 105 may be any network providing communication between the various data centers 110, 120, 130. In various embodiments, service provider network 105 may include the Internet. Further, communication over the service provider network 105 may be encrypted and may be transported according to a virtual private network (VPN). Various additional or alternative arrangements for providing connectivity will be apparent.

Data centers 110, 120, 130 may each represent a location of the service provider hosting cloud resources. In various embodiments, data centers 110, 120, 130 may be geographically distributed. For example, data center 1 110 may be located in New Jersey, data center 2 120 may be located in Ottawa, and data center 3 130 may be located in Paris. Each data center 110, 120, 130 may provide various cloud resources such as, for example, processing, storage, or application execution.

The operations of service provider cloud 100 may be controlled by one or more controllers such as controller 112. Controller 112 may include hardware resources such as a one or more processors, memory, storage, a network interface, or a user interface. In various embodiments, controller 112 may also include a virtual machine utilizing hardware resources to provide the described functionality. Controller 112 may perform various management functions such as receiving requests for resources and provisioning such resources at an appropriate data center 110, 120, 130 within the cloud 100. Controller 112 may select a data center 110, 120, 130 based on factors such as geography or current data center load. For example, if the resources are to be used by a client located in New Jersey, controller 112 may provision the requested resources in data center 1. As another example, if controller 112 determines that data center 2 120 currently has the smallest load, controller 12 may provision the new resources in data center 2 120. It will be apparent that alternative or additional factors, or combinations thereof, may be considered by controller 112 selecting a data center 110, 120, 130.

Each data center 110, 120, 130 may include devices for providing cloud resources such as, for example, processing, storage, or application execution. As shown, data center 1 110 may include servers 114, 116; data center 2 120 may include servers 122, 124, 126; and data center 3 130 may include servers 132, 134, 136, 138. It will be apparent that the number of servers in each data center may vary and that each data center may include fewer or additional servers (not shown). Each server 114, 116, 122, 124, 126, 132, 134, 136, 138 may be a server, server blade, personal computer, laptop, tablet, storage device, or other device capable of sharing hardware resources. For example, server 114 may be a server blade hosting a hypervisor and one or more virtual machines while server 116 may include a network attached storage device. Further, in various embodiments, controller 112 may also provide cloud resources for use by enterprises and other clients. Various alternative and additional arrangements will be apparent to those of skill in the art.

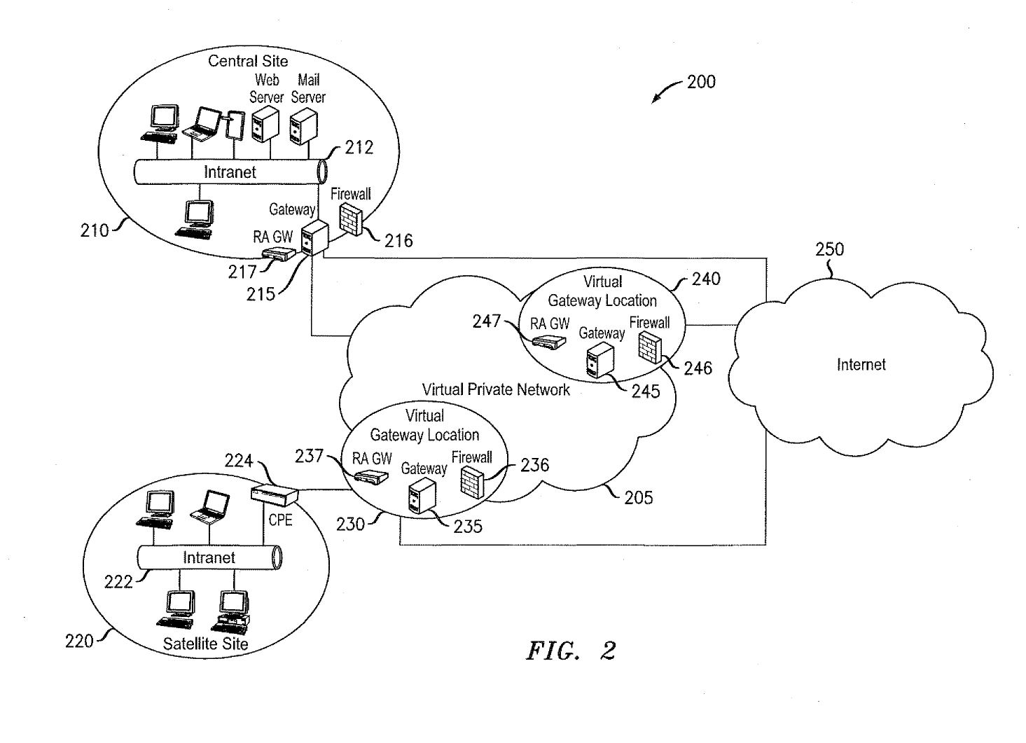

FIG. 2 illustrates an exemplary distributed enterprise network architecture 200. Distributed enterprise network may include a virtual private network (VPN) 205 providing connectivity between a central site 210 and one or more satellite sites such as satellite site 220. VPN 205 may be any type of VPN configured over an underlying network of routing devices and, in some embodiments, may include routing devices from the Internet 250. As will further be apparent in view of the description below, VPN 205 may include one or more devices belonging to a service provider cloud, such as service provider cloud 100.

Central site 210 may include a local intranet 212 to which a number of client devices may be connected. Intranet 212 may also be connected to a gateway 215, firewall 216, and remote access gateway 217. Gateway 215 may be a device configured to enable communication between device attached to local intranet 212 and other devices outside of intranet 212. As such, gateway 215 may forward packets destined for other devices attached to the distributed enterprise network over VPN 205. Further, gateway 215 may also forward packets destined for devices outside the distributed enterprise network to Internet 250. In doing so, gateway 215 may provide policy-controlled access to Internet 250.

Firewall 216 may be a device that provides traffic filtering to prevent unauthorized access to enterprise network 200. For example, firewall 216 may monitor at least some traffic passing through gateway 215 or remote access gateway 217 to identify and block malicious or otherwise undesirable traffic. In various embodiments, firewall 216 may be included in the same physical device as gateway 215.

Remote access gateway 217 may be a device that provides remote access to VPN 205 and devices connected thereto. Remote access gateway 217 may establish secure connections, such as IPSec tunnels, with devices connected to the Internet 250 or otherwise external from VPN 205. Traffic received over such secure connections may be passed by remote access gateway 217 either to gateway 215 for further processing or directly toward the receiving device, either via VPN 205 or intranet 212. Various additional functionality for remote access gateway 217 will be apparent. In various embodiments, remote access gateway may be included in the same physical device as gateway 215 or firewall 216.

Central site 210 may further provide one or more centralized services. For example, central site 210 may host a mail server or a web server. These services may be accessible from inside the enterprise network or from the external Internet 250. Central site 210 may further include one or more servers (not shown) configured to interface with a service provider controller, such as controller 112. Such servers may upload policies or VM images to the controller 112 or other data centers 110, 120, 130, and may transmit other instructions on the service provider should support the enterprise network, such as for example establishing one or more virtual gateway locations 230, 240, as will be explained in greater detail below.

Satellite site 220 may be located at location geographically distributed from central site 210. For example, central site 210 may be located in New Jersey while satellite site 220 may be located in Ottawa. As will be understood, distributed enterprise network 200 may include numerous additional satellite sites (not shown) that are further geographically distributed. Satellite site 220 may include a local intranet 222 to which a number of devices may be connected. Intranet 222 may also be connected to a customer premise equipment device (CPE) 224 that enables communication between intranet 222 and other devices attached to VPN 205. In various embodiments CPE 224 may be a layer 2 device that bridges the intranet 222 with other layer 2 devices provided by the service provider. In other embodiments, such as those include larger sites or multiple subnets on a site, the CPE 224 may be a layer 3 device connected to another layer 3 device that advertises the various routes in the enterprise.

Traffic originating from satellite site 220 may be passed by CPE to a virtual gateway location 230. Virtual gateway location 230 may be housed in a cloud datacenter of the service provider that is geographically close to satellite site 220. For example, virtual gateway location 230 may be hosted at data center 2 120 of service provider cloud 100 because both data center 2 120 and satellite site 220 may be located in Ottawa. Virtual gateway 230 may be manually established by an instruction sent by an operator or device of the enterprise or may be dynamically created by the service provider based on policies provided by the enterprise.

Virtual gateway location 230 may provide functionality similar to that provided by one or more of gateway 215, firewall 216, and remote access gateway 217. As such, virtual gateway location 230 may be seen to include gateway 235, firewall 236, and remote access gateway 237. These components may be realized by one or more virtual machines executed by the hardware of the data center to provide functions similar to those described above. For example, gateway 235 may provide policy-controlled access to the Internet 250, firewall 236 may block unauthorized traffic, and remote access gateway 237 may provide secure VPN access to remote devices. In various embodiments, the various virtual machines may be established from images of a virtual machine, or “templates,” present at the hosting data center. Such templates may define the desired operation of the gateway, firewall, or remote access gateway, and may include one or more signed policies.

By providing a virtual gateway location, the load placed on the VPN 205 may be reduced. For example, devices at satellite site 220 may be able to access external devices on the Internet 250 via gateway 235 instead of gateway 215. As such, VPN 205 may not have to transport all such Internet traffic between central site 200 and satellite site 220. Other efficiencies may also be introduced. For example, remote clients located in Ottawa may be provided access via the closer remote access gateway 237, which may reduce the number of hops that such traffic travels to its destination. Various additional benefits will be apparent.

Distributed enterprise network 200 may also include virtual gateway location 240. Like virtual gateway location 230, virtual gateway location 240 may include one or more virtual machines to provide gateway 245, firewall 246, and remote access gateway 247 functionalities. Unlike virtual gateway location 230, virtual gateway location 240 may not be associated with any satellite site or customer premise equipment. As such, virtual gateway location 240 may constitute a “virtual site.” Virtual gate way location 240 may be established near locations where the enterprise does not maintain a physical presence but has a number of remote workers in that location. Thus, the enterprise may not maintain any physical presence in Paris but may nonetheless provide a virtual gateway location 240 hosted by the service provider at data center 130 for remote workers located in Paris. As with virtual gateway location 230, virtual gateway location 240 may be manually established by an instruction sent by an operator or device of the enterprise or may be dynamically created by the service provider based on policies provided by the enterprise. Such establishment may be performed by a controller such as controller 112. For example, controller 112 may be provided with a policy that if over fifty remote users within a 100 mile range of each other are connected to the VPN 205 and are more than 200 miles away from the nearest remote access gateway, then a virtual site should be established. Thereafter, controller 112 may determine that one hundred users in Paris are remotely connected to either remote access gateway 217 or remote access gateway 237, determine that the policy has been met, and establish virtual gateway location 240. Thereafter, the users in Paris may be relocated to remote access gateway 247.

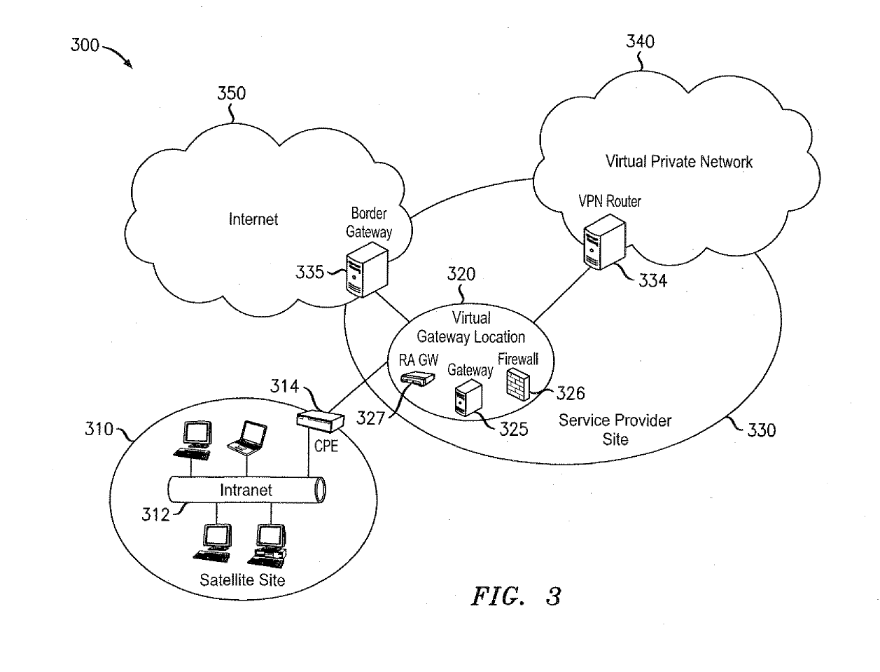

FIG. 3 illustrates an exemplary routing architecture 300 for a virtual gateway location. Exemplary routing architecture 300 may, in part, correspond to a portion of distributed enterprise network 200. For example, satellite site 310, intranet 312, and CPE 314 may correspond to satellite site 220, intranet 222, and CPE 224. Further, virtual gateway location 320, gateway 325, firewall 326, and remote access gateway 327 may correspond to virtual gateway location 230, gateway 235, firewall 236, and remote access gateway 237. VPN 340 may correspond to VPN 205 and Internet 350 may correspond to Internet 250.

As described above, gateway 325 may provide both VPN and Internet connectivity to satellite site 310. As such, gateway 325 may be in communication with a VPN router 334 and a border gateway 335. VPN router 334 may be configured to receive packets tagged or otherwise identified as belonging to VPN 340 and may forward such packets over VPN 340 toward their destination. For example, VPN router 334 may be configured with one or more BGP/MPLS tunnels (not shown) over Internet 350 or another network (not shown) to provide VPN 340. Various additional methods for VPN router 334 to enable various types of VPNs will be apparent.

Border gateway 335 may transfer packets between the open Internet 350 and virtual gateway location 320. Border gateway 335 may perform numerous additional functions associated with provider edge devices such as, for example, advertisement of one or more addresses to Internet 350. In various embodiments, VPN router 334 and border gateway 335 may be the same device. In such embodiments, this device may be configured to send both VPN traffic and normal Internet traffic as described. Further, in various embodiments the VPN router 334 or border gateway 335 may be realized as a virtual machine also hosted at service provider site 330.

Virtual gateway 325 may be a layer 3 device which runs as a virtual machine at the service provider site 330 and may establish connectivity with other gateways and virtual gateways using VPN technologies such as BGP/MPLS VPs via VPN router 334. Upon receiving packets from CPE 314 that belong to VPN 340, gateway 325 may forward such packets to VPN router 334 such that they may reach a gateway at an appropriate site within the distributed enterprise network.

Upon receiving packets from CPE 314 that include destination addresses located external to the enterprise network, gateway 325 may forward such packets to border gateway 335. Various methods may be used to ensure that packets sent back from the Internet device to the initiating device at satellite site 10 arrive via gateway 325 instead of a gateway at a central site or another virtual gateway. In some embodiments, gateway 325 may perform network address translation (NAT) for accessing the Internet and may insert its own publicly addressable IP address as the source address of packets sent to border gateway 335. Thereafter, response packets may be addressed to the address of the gateway, which may then forward the packet to the appropriate device at satellite site 310. In other embodiments, such as those embodiments wherein an enterprise uses public addressing at a site, the virtual gateway 325 may advertise routes to the border gateway 335, which may consolidate the addresses with other service provider and enterprise addresses before advertising the addresses to the Internet 350.

With regard to connections originating from the Internet 350, remote clients may connect to a remote access gateway such as remote access gateway 327 in multiple ways. Where the enterprise or client wishes to connect to the closest remote access gateway, the client may use geolocation-based domain name system (DNS) resolution. For example, a single domain name may be used to point to all remote access gateways and may resolve to a different IP address based on the geographic location of the client. Where the enterprise desires each remote client to connect to a fixed or designated remote access gateway, each remote access gateway may be assigned a unique fully qualified domain name (FQDN) to which a remote client connects. In other cases, a client may connect to a centralized server, such as a server hosted at the enterprise central site, which then identified the remote access gateway to which the client should connect. For example, the server may pass a cryptographic token to the client which is then used to connect to the remote access gateway.

It will be understood that various routing functionality described in relation to virtual gateway location 320 will also be applicable to other virtual gateway locations (not show) that are established as virtual sites, such as virtual gateway location 240.

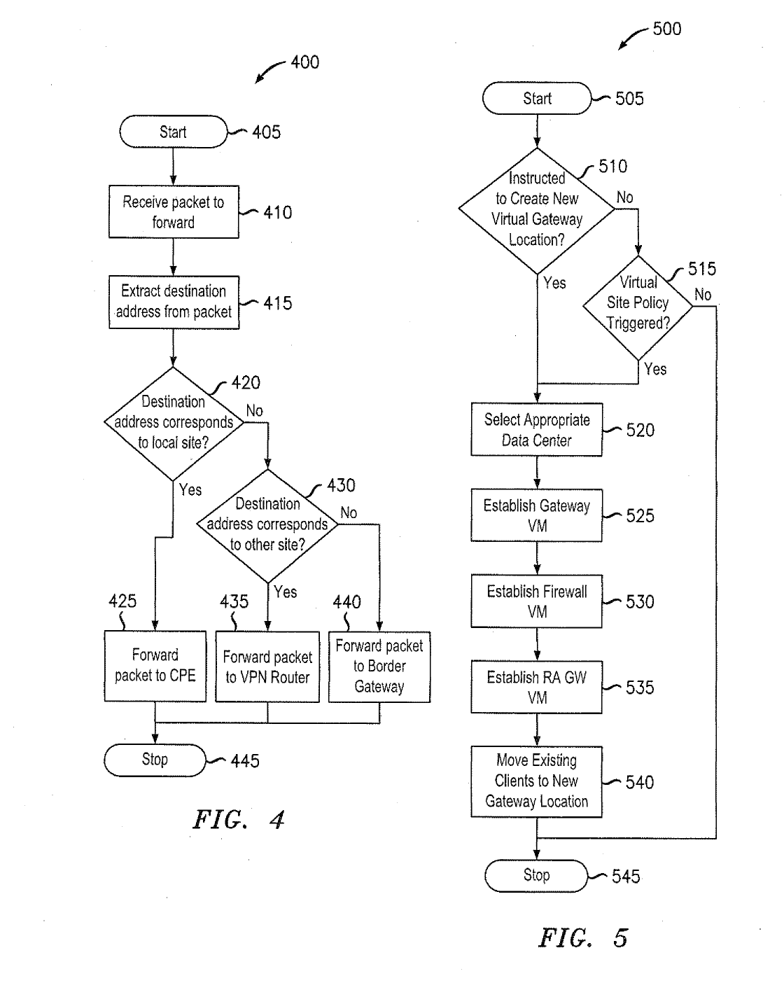

FIG. 4 illustrates an exemplary method 400 for forwarding packets at a virtual gateway site. Method 400 may be performed by a gateway such as gateway 215, 235, 245, or 325. Method 400 may begin in step 405 and proceed to step 410 where the gateway may receive a packet to forward. Where the gateway is a virtual gateway, the packet may be received via an interface of the underlying hardware from a CPE, a VPN router, a border gateway, a remote access gateway, or a firewall. Next, in step 415, the gateway may extract a destination address from the packet to determine how the packet should be forwarded. In various embodiments, the gateway may be provided with a correlation of various addresses or address ranges to the appropriate next hop device.

In step 420, the gateway may determine whether the extracted address corresponds to an address of a satellite site associated with the gateway. If so, the gateway may forward the packet to the CPE in step 425. Thereafter, the CPE may further forward the packet to the local intranet for delivery to the appropriate device. If the destination does not correspond to a local site, method 400 may instead proceed to step 430.

In step 430, the gateway may determine whether the destination address corresponds to a remote site within the enterprise, such as a different central site or satellite site. For example, the gateway may determine whether the packet constitutes VPN traffic. If so, the gateway may forward the packet to a VPN router. The VPN router may then handle forwarding the packet, over the VPN, toward the appropriate site. If, however, the packet is not destined for any site within the enterprise network, the gateway may determine that the packet is destined for a device attached to the Internet. In this case, method 400 may proceed from step 430 to step 440, where the gateway may forward the packet to a border gateway. The border gateway may then forward the packet over the Internet toward the appropriate device. Method 400 may proceed from step 425, step 435, or step 440 to end in step 445.

It will be apparent that, in various embodiments, the gateway may perform additional steps. For example, upon receiving a packet in step 410 or before forwarding a packet to a border gateway in step 440, the gateway may apply one or more access policies to the packet or a flow to which it belongs. In such embodiments, the policy may, for example, cap bandwidth for a user or block access to certain devices or websites on the Internet. Various additional steps for performing various gateway functions will be apparent.

FIG. 5 illustrates an exemplary method 500 for establishing a virtual gateway site. Method 500 may be performed by a controller of the service provider, such as controller 112. Method 500 may begin in step 505 and proceed to step 510 where the controller may determine whether the controller has received an instruction to create a new virtual gateway location for an enterprise. For example, the controller may receive such an instruction from a device or operator of the enterprise. If such an instruction has been received, method 500 may proceed to step 520. If not such instruction has been received, method 500 may proceed to step 515.

In step 515, the controller may determine whether a virtual site policy has been triggered. As explained above, the controller may have access to one or more policies for determining when a virtual site should be established. Such policies may be provided by a device or operator of the enterprise. If the controller determines that a current state of the enterprise network has triggered a virtual site policy, such as if a large number of users are connected in a geographic area, method 500 may proceed to step 520. Otherwise, method 500 may proceed to end in step 545.

In step 520, the controller may select an appropriate data center to host the new virtual gateway location. Such selection may be based on one or more factors such as geographic location of a satellite site to be supported, geographic location of remote access users, relative load of potential data centers, or the capabilities of potential data centers. After selecting a data center to host the new virtual gateway location, method 500 may proceed to step 525.

In step 525, the controller may establish a gateway virtual machine at the selected data center. This gateway virtual machine may be established based on a template available at to the controller or the selected data center. The template may include code and configurations used to provide service to the satellite site or remote users. In a similar manner, the controller may establish firewall and remote access gateway virtual machines in steps 530 and 535, respectively, based on appropriate templates. In various embodiments, the one virtual machine may provide the functionality of two or more of the gateway, firewall, and remote access gateways. In such embodiments, two or more of steps 525, 530, 535 may be performed at the same time.

After establishment of one or more virtual machines, method 500 may proceed to step 540. In step 540, the controller may relocate existing clients to the new virtual gateway location, as appropriate. For example, if a number of remote users are located in the geographic area of the selected data center, the controller may ensure that, going forward, such remote clients access the enterprise network via the remote access gateway established in step 535. For example, the controller may assign new IP addresses to those clients or may allow a network virtualization layer to handle movement of the already-assigned IP addresses in a manner similar to mobile IP. Method 500 may then proceed to end in step 545.

It will be apparent that the controller may also handle tearing down a virtual gateway location when the virtual gateway location is no longer needed. For example, when the load on a virtual site decreases, the enterprise may request or define in a policy that the virtual site should be removed to save costs. In various embodiments, the controller may accomplish this tearing down by first marking the virtual gateway location for destruction, which may not allow for any new connections to be established. Next, the controller may move any existing connections to other appropriate sites by, for example, reassigning address blocks from the site to be destroyed among the remaining sites. Finally, any site-to-site VPN connections associated with the virtual gateway location may be destroyed and the resources associated with the virtual machines may be released.

According to the foregoing, various embodiments enable the provision of policy-controlled external network access to distributed enterprise networks that reduces the load on internal resources. For example, by establishing virtual gateways and other functionalities in a service provider cloud, an enterprise may provide Internet access and other services in geographic areas closer to the devices to be serviced. This may decrease the load placed on the VPN because less traffic may be routed through a central site.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a cloud controller for providing a network service, the method comprising:
determining that a new virtual gateway location should be created;
selecting a data center of a plurality of data centers to host the new virtual gateway location; and
establishing a virtual gateway at the selected data center, wherein the virtual gateway is configured to provide at least one device with connectivity to a Virtual Private Network (VPN) and connectivity to the Internet.

2. The method of claim 1, further comprising establishing a virtual remote access gateway at the selected data center, wherein the virtual remote access gateway is configured to provide a device outside the VPN with access to the VPN.

3. The method of claim 1, further comprising establishing a virtual firewall at the selected data center, wherein the virtual firewall is configured to filter traffic associated with the virtual gateway.

4. The method of claim 1, wherein the step of determining that a new virtual gateway location should be created comprises receiving an instruction to create a new virtual gateway location.

5. The method of claim 1, wherein the step of determining that a new virtual gateway location should be created comprises:
receiving, from an enterprise server, a virtual site policy, wherein the virtual site policy includes criteria for determining when a new virtual gateway location should be created; and
determining that the criteria have been met by the current state of the Virtual Private Network.

6. The method of claim 1, wherein the at least one device includes customer premise equipment.

7. The method of claim 1, wherein the step of selecting a data center of a plurality of data centers to host the new virtual gateway location is performed based on the geographic distance between the data center and the at least one device.

8. A method performed by at least one cloud device for providing a network service, the method comprising:
hosting a gateway virtual machine, wherein the gateway virtual machine performs the steps of:
receiving, via an interface of the at least one cloud device, a first packet to be forwarded;
extracting a destination address from the packet;
determining whether the destination address corresponds to a remote enterprise site or a device on the Internet;
transmitting the first packet to a Virtual Private Network (VPN) router based on a correspondence between the destination address and a remote enterprise site; and
transmitting the first packet to a border gateway based on a correspondence between the destination address.

9. The method of claim 8, wherein the gateway virtual machine receives the first packet from a customer premise equipment device.

10. The method of claim 8, wherein the at least one cloud device further hosts a remote access gateway virtual machine that performs the steps of:
receiving a second packet from the Border Gateway; and
forwarding the second packet to a device connected to the VPN.

11. The method of claim 8, wherein the at least one cloud device further hosts a firewall virtual machine that filters packets associated with the gateway virtual machine.

12. The method of claim 8, wherein the step of transmitting the first packet to a border gateway comprises performing network address translation (NAT).

13. The method of claim 8, further comprising advertising, by the gateway virtual machine to the border gateway, a route to a device from which the first packet originated.

14. The method of claim 8, wherein at least one of the VPN router and the border gateway are virtual machines hosted by the at least one cloud device.

15. A cloud controller for providing a network service, the cloud controller comprising:
a memory; and
a processor communicatively connected to the memory configured to:
determine that a new virtual gateway location should be created,
select a data center of a plurality of data centers to host the new virtual gateway location, and
establish a virtual gateway at the selected data center, wherein the virtual gateway is configured to provide at least one device with connectivity to a Virtual Private Network (VPN) and connectivity to the Internet.

16. The cloud controller of claim 15, wherein the processor is further configured to establish a virtual remote access gateway at the selected data center, wherein the virtual remote access gateway is configured to provide a device outside the VPN with access to the VPN.

17. The cloud controller of claim 15, wherein the processor is further configured to establish a virtual firewall at the selected data center, wherein the virtual firewall is configured to filter traffic associated with the virtual gateway.

18. The cloud controller of claim 15, wherein, in determining that a new virtual gateway location should be created, the processor is configured to:
receive, from an enterprise server, a virtual site policy, wherein the virtual site policy includes criteria for determining when a new virtual gateway location should be created; and
determine that the criteria have been met by the current state of the Virtual Private Network.

19. The cloud controller of claim 15, wherein the at least one device includes customer premise equipment.

20. The cloud controller of claim 15, wherein the processor is configured to perform the selection of a data center of a plurality of data centers to host the new virtual gateway location based on the geographic distance between the data center and the at least one device.
